(19) United States
(12) Patent Application Publication
(10) Pub. No.: US 2017/0288997 A1
(43) Pub. Date: Oct. 5, 2017

(54) MANAGEMENT SYSTEM AND MANAGEMENT METHOD

(71) Applicant: FUJITSU LIMITED, Kawasaki-shi (JP)

(72) Inventor: Mamoru ARISUMI, Kawasaki (JP)

(73) Assignee: FUJITSU LIMITED, Kawasaki-shi (JP)

(21) Appl. No.: 15/460,955

(22) Filed: Mar. 16, 2017

(30) Foreign Application Priority Data
Mar. 29, 2016 (JP) 2016-066049

(51) Int. Cl. H04L 12/26; H04L 12/24

(52) U.S. Cl. CPC H04L 43/0811; H04L 41/0869; H04L 41/0853

(57) ABSTRACT

A management system includes a first switch and a second switch. The first switch includes a first processor configured to transmit a first instruction when information on a first connection state of first equipment is not updated. The second switch includes a second processor configured to receive the first instruction. The second processor is configured to determine, on basis of second information, whether the first connection state is to be notified to the first switch at a present time. The second information is related to past connection states of the first equipment. The second processor is configured to notify, in a case where it is determined that the first connection state is not to be notified, the first switch of an instruction to transmit the first instruction again after a predetermined time is elapsed.

### CROSS-REFERENCE TO RELATED APPLICATION

This application is based upon and claims the benefit of priority of the prior Japanese Patent Application No. 2016-066049, filed on Mar. 29, 2016, the entire contents of which are incorporated herein by reference.

### FIELD

The embodiment discussed herein is related to a management system and a management method.

### BACKGROUND

FIG. 1 is a diagram illustrating an example of a network configuration. A network 1000 in FIG. 1 includes a network_A and a network_B. The network_A and the network_B are communicably coupled to each other through a router 1100. The network_A includes a representative Layer 2 (L2) switch 1201, an L2 switch 1202, a management server 1301, and a server 1302. The network_B includes an L2 switch 1203.

The management server 1301 at the network_A side is associated with and coupled to the representative L2 switch 1201 and is communicably coupled to another server. The representative L2 switch 1201 is communicably coupled to the management server 1301. The server 1302 at the network_A side is associated with and coupled to the L2 switch 1202 and is communicably coupled to another server. The L2 switch 1202 is communicably coupled to the server 1302. The management server 1301 manages a server (here, server 1302) coupled to the network_A or the network_B.

Here, it is assumed that a server 1303 is newly associated with and coupled to the L2 switch 1203 at the network_B side. The L2 switch 1203 is communicably coupled to the server 1303. The server 1303 newly coupled to the network_B transmits an address resolution protocol (ARP) packet. When the ARP packet transmitted from the server 1303 is received, the L2 switch 1203 references server information on detected servers, which is stored in the L2 switch 1203. The L2 switch 1203 references the server information stored in the L2 switch 1203 to determine whether the server 1303 is a newly coupled server.

When it is determined that the server 1303 is a new server, the L2 switch 1203 transmits, to the representative L2 switch 1201, detection information indicating that the server 1303 is detected as a new server. The representative L2 switch 1201 transmits the detection information to the management server 1301. Thus, the management server 1301 may detect the newly added server 1303 and manage the server 1303.

A technology is known which acquires a monitored state of an agent without using a technical risk assessment program (TRAP) in a network management system using a simple network management protocol (SNMP).

Related techniques are disclosed in, for example, Japanese Laid-Open Patent Publication No. 2001-024635.

### SUMMARY

According to an aspect of the present invention, provided is a management system including a first switch and a second switch. The first switch includes a first memory and a first processor coupled to the first memory. The first processor is configured to transmit a first instruction when information on a first connection state of first equipment is not updated. The second switch includes a second memory and a second processor coupled to the second memory. The second processor is configured to receive the first instruction. The second processor is configured to determine, on basis of second information, whether the first connection state is to be notified to the first switch at a present time. The second information is related to past connection states of the first equipment. The second processor is configured to notify, in a case where it is determined that the first connection state is not to be notified, the first switch of an instruction to transmit the first instruction again after a predetermined time is elapsed.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network configuration;

FIG. 2 is a diagram illustrating an example of a network configuration according to an embodiment;

FIG. 3 is a diagram illustrating an example of a configuration of a representative L2 switch;

FIG. 4 is a diagram illustrating an example of a configuration of an L2 switch;

FIG. 5 illustrates an example of a configuration of an apparatus according to a first case;

FIG. 6 illustrates an example of a detected-equipment table within a representative L2 switch according to the first case;

FIG. 7 is a diagram illustrating an example of access statistics data according to the first case;

FIG. 8 illustrates an example of the detected-equipment table within the representative L2 switch according to the first case;

FIG. 9 illustrates an example of a configuration of an apparatus according to a second case;

FIG. 10 is a diagram illustrating an example of access statistics data according to a third case;

FIG. 11 is a diagram illustrating an example of access statistics data according to a fourth case;

FIG. 12 is a diagram illustrating an example of access statistics data according to a fifth case;

FIG. 13 is a diagram illustrating an example of a hardware configuration of the representative L2 switch and the L2 switch;

FIG. 14A is a flowchart illustrating an example of processing performed by the L2 switch;

FIG. 14B is a flowchart illustrating an example of processing performed by the L2 switch;

FIG. 14C is a flowchart illustrating an example of processing performed by the L2 switch;

FIG. 15 is a flowchart illustrating an example of processing performed by a monitor unit of the representative L2 switch; and

FIG. 16 is a flowchart illustrating an example of processing performed by an update unit of the representative L2 switch.

### DESCRIPTION OF EMBODIMENT

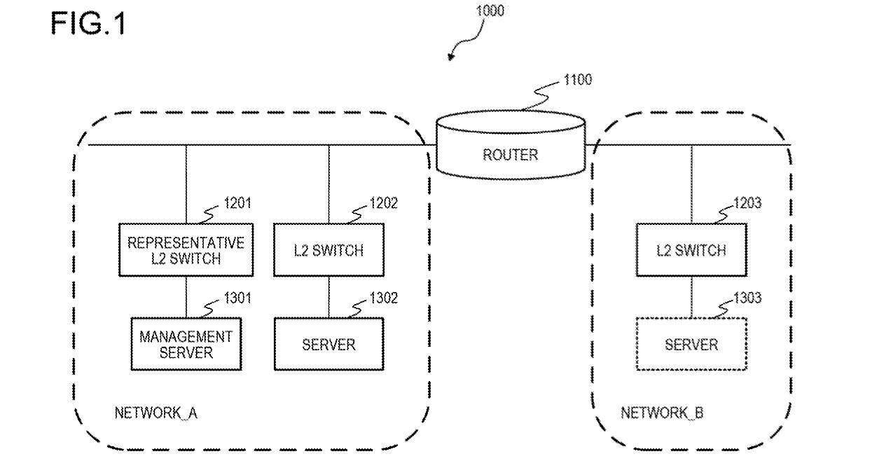

In the example in FIG. 1, the network 1000 includes servers, L2 switches, and a router. The network 1000 may additionally include equipment such as a communication device. The management server 1301 may manage the other equipment. In the following, the servers and the other equipment are collectively referred to as “equipment”.

When any equipment is detached from a network, the management server 1301 is unable to detect a connection state of the detached equipment. Similarly, the management server 1301 is also unable to detect a connection state of equipment of which communication is disabled by, for example, a failure or equipment that is temporarily powered OFF due to, for example, maintenance or a scheduled operation.

For that reason, when a power is temporarily turned OFF due to, for example, the maintenance or scheduled operation, a work occurs for excluding the equipment from equipment to be managed.

### Embodiment

A representative L2 switch according to an embodiment inquires, using stored information on detected equipment, of another L2 switch about a network connection state of equipment. The representative L2 switch may also be referred to as, for example, a management switch. Thus, the representative L2 switch may check a network connection state of equipment coupled to another L2 switch.

The representative L2 switch causes another L2 switch to periodically collect information relating to a network connection state of equipment and store therein statistical data. The statistical data is history information related to the network connection state of the equipment. As a result, it is possible to determine equipment that is temporarily detached from the network in a planned way due to, for example, powering-OFF during night by a scheduled operation or a periodically performed maintenance work. Based on the statistical data, the management server may prevent erroneous information from being transmitted to the management server. The erroneous information indicates that equipment is in a state of being uncoupled to the network while the equipment is only temporarily detached from the network due to, for example, maintenance or a scheduled operation.

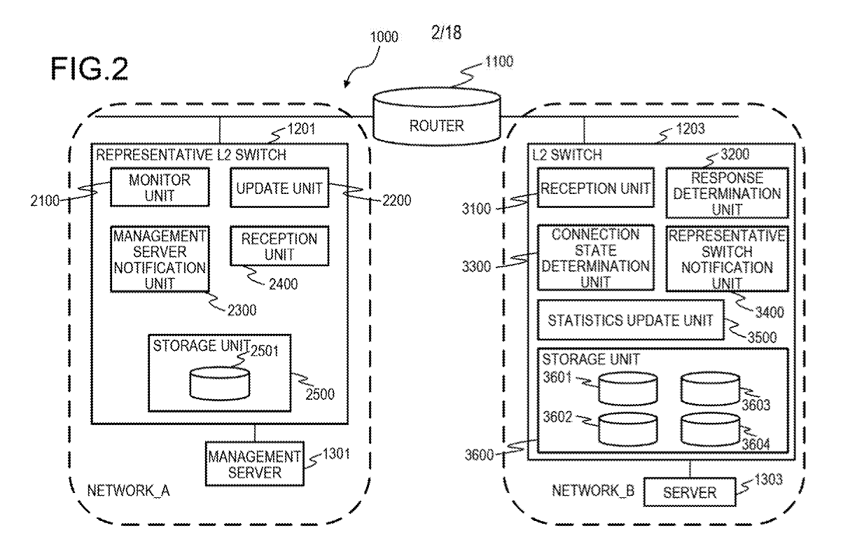

FIG. 2 is a diagram illustrating an example of a network configuration according to the present embodiment. The network 1000 in FIG. 2 includes a network_A and a network_B. The network_A and the network_B are communicably coupled to each other through the router 1100. The network_A in FIG. 2 includes a representative L2 switch 1201 and a management server 1301. The network_B includes an L2 switch 1203 and a server 1303. The management server 1301 manages the equipment included in the network_A and the network_B. According to the present embodiment, each of the representative L2 switch 1201 and the L2 switch 1203 is equipped with a mechanism for checking whether a server (equipment) coupled to each L2 switch is coupled to the network.

The representative L2 switch 1201 includes a monitor unit 2100, an update unit 2200, a management server notification unit 2300, a reception unit 2400, and a storage unit 2500. The L2 switch 1203 includes a reception unit 3100, a response determination unit 3200, a connection state determination unit 3300, a representative switch notification unit 3400, a statistics update unit 3500, and a storage unit 3600. In the following, an example of processing for checking whether a server (equipment) is coupled to the network will be described.

(A1) The monitor unit 2100 of the representative L2 switch 1201 periodically references a detected-equipment table 2501 stored in the storage unit 2500. The detected-equipment table 2501 stores therein information on detected equipment. The monitor unit 2100 transmits a check instruction instructing to check a connection state of equipment (target equipment), for which information in the detected-equipment table 2501 is not updated for a predetermined time or more, to an L2 switch to which the target equipment is coupled. Here, it is assumed that the target equipment is the server 1303. Thus, the monitor unit 2100 of the representative L2 switch 1201 transmits the check instruction instructing to check the connection state of the server 1303 to the L2 switch 1203.

(A2) The reception unit 3100 of the L2 switch 1203 receives the check instruction from the representative L2 switch 1201.

(A3) The response determination unit 3200 of the L2 switch 1203 determines whether the connection state is to be notified to the representative L2 switch 1201, based on access statistics data 3601 stored in the storage unit 3600. The response determination unit 3200 checks, based on the access statistics data 3601, whether the present time falls within a time zone during which the target equipment is temporarily detached from the network in a planned way due to, for example, powering-OFF during night by a scheduled operation or a periodically performed maintenance work, and determines whether the connection state of the target equipment is to be determined.

(A3-1) When there is a problem in determining the connection state of the target equipment at the present time, the representative switch notification unit 3400 of the L2 switch 1203 notifies the representative L2 switch 1201 of a recheck instruction. The reception unit 2400 of the representative L2 switch 1201 receives the recheck instruction. When the recheck instruction is received, the representative L2 switch 1201 repeats the processing again from (A1) after a predetermined time is elapsed.

(A3-2) When there is no problem in determining the connection state of the target equipment at the present time, the connection state determination unit 3300 of the L2 switch 1203 determines whether the target equipment is coupled to the network. Specifically, the connection state determination unit 3300 determines whether the target equipment is coupled to the network, based on a media access control (MAC) address table 3602 or port linkup information 3603 stored in the storage unit 3600.

(A4) The statistics update unit 3500 of the L2 switch 1203 reflects the MAC address table 3602 or port linkup information 3603 into the access statistics data 3601. The statistics update unit 3500 periodically reflects the MAC address table 3602 or port linkup information 3603 into the access statistics data 3601.

(A5) The connection state determination unit 3300 of the L2 switch 1203 reflects network connection state information of the target equipment into a detected-equipment table 3604. The representative switch notification unit 3400 of the L2 switch 1203 notifies the representative L2 switch 1201 of the network connection state information of the target equipment.

(A6) The reception unit 2400 of the representative L2 switch 1201 receives the network connection state information of the target equipment from the L2 switch 1203.

(A7) The update unit 2200 of the representative L2 switch 1201 updates the detected-equipment table 2501 stored in the storage unit 2500, based on the received network connection state information of the target equipment.

(A8) The management server notification unit 2300 of the representative L2 switch 1201 notifies the management server 1301 of the network connection state information of the target equipment.

As such, the L2 switch 1203 checks whether the present time falls within a time zone during which the target equipment is temporarily detached from the network in a planned way due to, for example, powering-OFF during night by a scheduled operation or a periodically performed maintenance work, based on the access statistics data 3601. As a result, the L2 switch 1203 may determine whether a connection state of the target equipment is to be notified to the representative L2 switch 1201 at the present time zone. The L2 switch 1203 notifies the management server 1301 side of the connection state of the target equipment at a time zone during which the connection state of the target equipment is to be notified. The L2 switch 1203 does not notify the management server 1301 side of the connection state of the target equipment at a time zone during which the connection state of target equipment is not to be notified.

As a result, the management server 1301 may prevent erroneous information from being transmitted to the management server 1301. The erroneous information indicates that equipment is in a state of being uncoupled to the network while the equipment is only temporarily detached from the network due to, for example, maintenance or a scheduled operation.

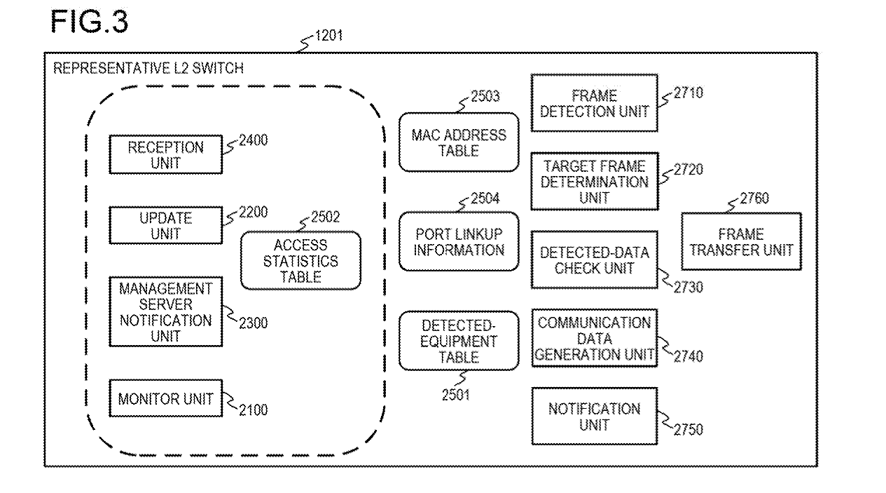

FIG. 3 is a diagram illustrating an example of a configuration of the representative L2 switch. The representative L2 switch 1201 in FIG. 3 includes functions related to switching processing in addition to the functions of the representative L2 switch 1201 in FIG. 2. The monitor unit 2100, the update unit 2200, the management server notification unit 2300, and the reception unit 2400 of the representative L2 switch 1201 in FIG. 3 are similar to those in FIG. 2 and thus are assigned with the same reference numerals.

The representative L2 switch 1201 in FIG. 3 includes an access statistics table 2502 in addition to the functions of the representative L2 switch 1201 in FIG. 2. The access statistics table 2502 is stored in the storage unit 2500. The access statistics table 2502 stores therein information on the connection states of the management server 1301 coupled to the representative L2 switch 1201 and other servers coupled to the representative L2 switch 1201.

The detected-equipment table 2501 of the representative L2 switch 1201 stores therein information on a server which is detected and coupled to the representative L2 switch 1201. The MAC address table 2503 stores therein MAC address information corresponding to the detected server. The Port Linkup information 2504 includes connection state information indicating whether the detected server is linked up with a port of the network.

The frame detection unit 2710 detects an Ethernet (registered trademark) frame sent from respective ports at the L2 switch side. A frame transfer unit 2760 updates the MAC address table 2503 and transfers the detected frame to a transfer destination. The frame detection unit 2710 also transmits the detected frame to a target frame determination unit 2720 when transmitting the detected frame to the frame transfer unit 2760. The target frame determination unit 2720 determines whether a transmission source of the frame is a new transmission source. A detected-data check unit 2730 identifies a port from which an input frame is input, and registers the port in the detected-equipment table 2501. A communication data generation unit 2740 generates data in order to notify the notification destination (management server 1301) of the frame. A notification unit 2750 notifies the management server 1301 of the generated data.

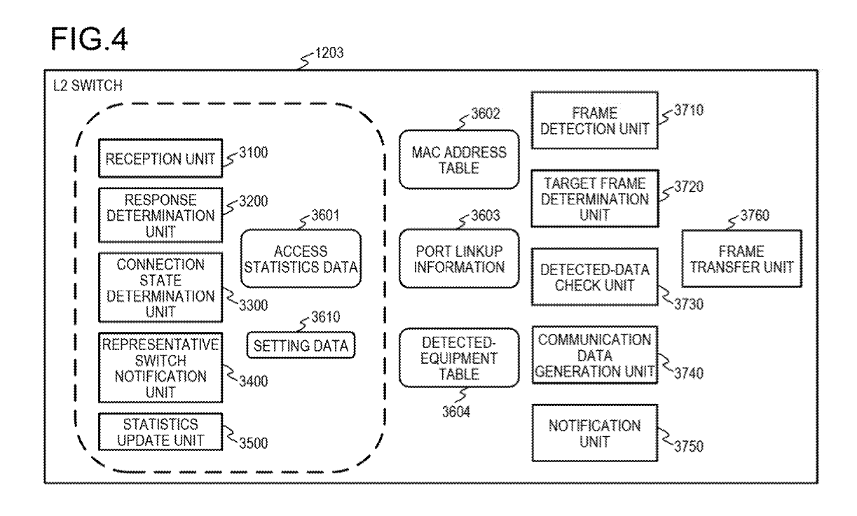

FIG. 4 is a diagram illustrating an example of a configuration of the L2 switch. Functions of the L2 switch 1203 in FIG. 4 similar to the functions of the L2 switch 1203 in FIG. 2 are assigned with the same reference numerals.

A frame detection unit 3710 of the L2 switch 1203 in FIG. 4 detects an Ethernet frame sent from a port of the representative L2 switch 1201 or another L2 switch. A frame transfer unit 3760 updates the MAC address table 3602 and transfers the detected frame to a transfer destination. The frame detection unit 3710 also transmits the detected frame to a target frame determination unit 3720 when transmitting the detected frame to the frame transfer unit 3760. The target frame determination unit 3720 determines whether a transmission source of the frame is a new transmission source. A detected-data check unit 3730 identifies a port from which an input frame is input and registers the port in the detected-equipment table 3604. A communication data generation unit 3740 generates data in order to notify the notification destination (e.g., server 1303) of the frame. A notification unit 3750 notifies, for example, the server 1303 of the generated data.

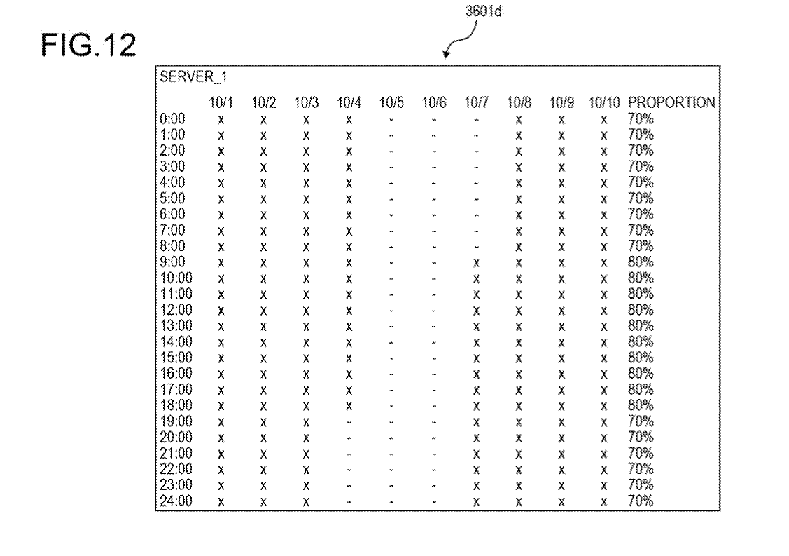

The L2 switch 1203 stores therein setting data 3610. The setting data 3610 includes, for example, a threshold value used by the response determination unit 3200, which will be described later with reference to FIG. 12.

First Case

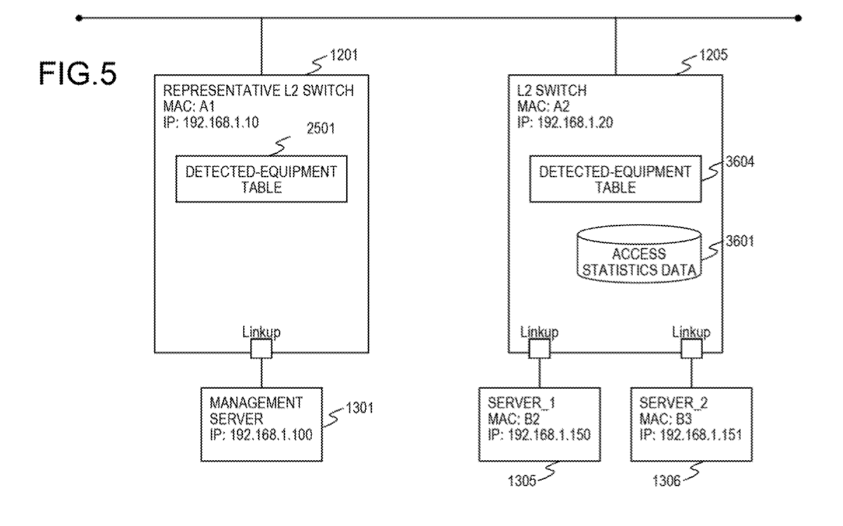

FIG. 5 illustrates an example of a configuration of an apparatus according to a first case. The representative L2 switch 1201 is coupled to the management server 1301. An L2 switch 1205 is coupled to a server 1305 and a server 1306. A configuration of the L2 switch 1205 is similar to the configuration of the L2 switch 1203 illustrated in FIG. 4.

The Internet Protocol (IP) address of the management server 1301 is “192.168.1.100”. The MAC address and the IP address of the representative L2 switch 1201 are “A1” and “192.168.1.10”, respectively.

The MAC address and the IP address of the L2 switch 1205 are “A2” and “192.168.1.20”, respectively. The MAC address and the IP address of the server 1305 are “B2” and “192.168.1.150”, respectively. The MAC address and the IP address of the server 1306 are “B3” and “192.168.1.151”, respectively.

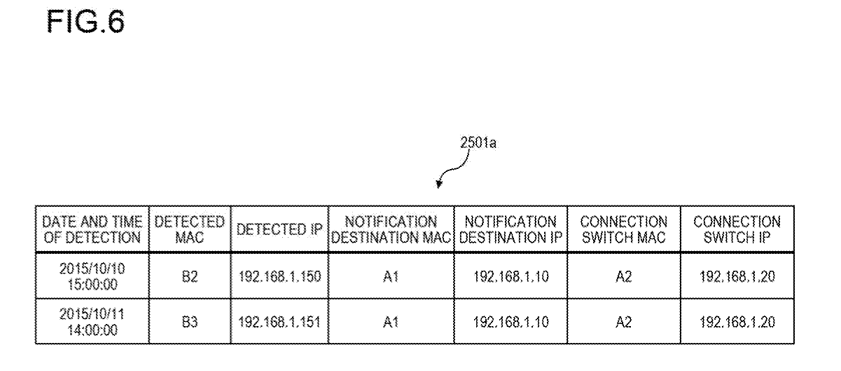

FIG. 6 illustrates an example of a detected-equipment table within the representative L2 switch according to the first case. A detected-equipment table 2501a in FIG. 6 is an example of the detected-equipment table before the connection state of a management target server is checked. The detected-equipment table 2501a is stored in the storage unit 2500 within the representative L2 switch 1201 in FIG. 5.

The detected-equipment table 2501a includes items for a detection date and time, a detected MAC, a detected IP, a notification destination MAC, a notification destination IP, a connection switch MAC, and a connection switch IP. The item for the detection date and time includes a date and time at which a server managed by the management server 1301 is detected. The servers managed by the management server 1301 are the server 1305 and the server 1306 in the example in FIG. 5. Thus, dates and times at which the server 1305 and the server 1306 are detected, respectively, are stored in the item for the date and time of the detection. The item for the detected MAC includes a MAC address of the management target server. The item for the detected IP includes an IP address of the management target server. The item for the notification destination MAC includes a MAC address of a notification destination (representative L2 switch 1201) to which the connection state is notified by the management target server. The item for the notification destination IP includes an IP address corresponding to the MAC address of the notification destination. The item for the connection switch MAC includes a MAC address of the L2 switch to which the management target server is coupled. The item for the connection switch IP includes an IP address corresponding to the connection switch MAC. The first row of the detected-equipment table 2501a indicates information relating to the server 1305. The second row of the detected-equipment table 2501a indicates information relating to the server 1306.

The representative L2 switch 1201 identifies a server that has passed, for example, a period of one day or more since the detection date and time of the detected-equipment table 2501a, and transmits a connection check instruction to an L2 switch to which the identified server is coupled. For example, it is assumed that the present time is “20:00:00, Oct. 11, 2015”. Then, for the server 1306, the period of one day or more has not elapsed since the detection of the server 1306. Thus, the representative L2 switch 1201 does not transmit a connection check instruction for the server 1306. On the other hand, the detection date and time of the server 1305 is “15:00:00, Oct. 10, 2015”. Then, for the server 1305, a period of one day or more has elapsed since the detection of the server 1305. Thus, the representative L2 switch 1201 transmits a connection check instruction for the server 1305.

When the connection check instruction is received from the representative L2 switch 1201, the L2 switch 1205 determines whether a connection state of the server 1305, which is the target of the connection check instruction, is to be notified. In this determination, access statistics data 3601 in FIG. 5 is used.

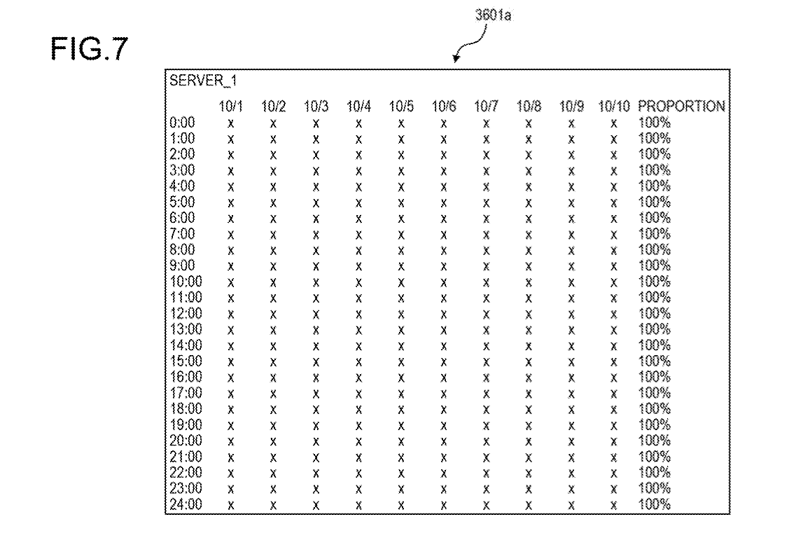

FIG. 7 is a diagram illustrating an example of access statistics data according to the first case. Access statistics data 3601a according to the first case is statistical data related to the server 1305, in the access statistics data 3601 within the L2 switch 1205 in FIG. 5. In the access statistics data 3601a, information on the network connection states at 0 minute of each hour in the past 10 days (October 1 to October 10) are stored.

The access statistics data 3601a includes items for a time, a day, and a proportion. The item for the time (row) includes time information of 0 o'clock to 24 o'clock. The item for the day (column) corresponds to 10 days from October 1 to October 10 in this example. Here, the network connection states of respective hours from October 1 to October 10 are represented as “x”. The “x” indicates that there is no problem in the connection to, for example, the server 1305. The item for the proportion represents a connection proportion (in the example of the embodiment, a proportion indicating days with no problem in the connection in the ten days, at a corresponding hour) of the connection state at each hour. The access statistics data 3601a indicates that, for example, the connection proportion at 20 o'clock is 100%, that is, the server 1305 is in the connection state at 20 o'clock for the 10 days.

Here, it is assumed that a connection check instruction is issued from the representative L2 switch 1201 at 20 o'clock. Then, 20 o'clock, which is the connection check instruction time, corresponds to a connection state of 100% (the server 1305 is in the connection state at 20 o'clock for the 10 days) and thus, the response determination unit 3200 of the L2 switch 1205 determines that the connection state of the server is to be notified. The connection state determination unit 3300 of the L2 switch 1205 checks the connection state of the server 1305, based on the MAC address table 3602 or the port linkup information 3603. Specifically, when the MAC address of the server 1305 is included in the MAC address table 3602, the connection state determination unit 3300 determines that the server 1305 is coupled. The connection state determination unit 3300 may determine the connection state, based on whether a port coupled to the server 1305 is linked up. The statistics update unit 3500 of the L2 switch 1205 reflects the connection state information into the access statistics data 3601. The connection state determination unit 3300 reflects the connection state information into the detected-equipment table 3604. Thereafter, the representative switch notification unit 3400 notifies the representative L2 switch 1201 of the network connection state information of the target equipment.

The update unit 2200 of the representative L2 switch 1201 updates the detected-equipment table 2501 stored in the storage unit 2500, based on the received network connection state information of the target equipment.

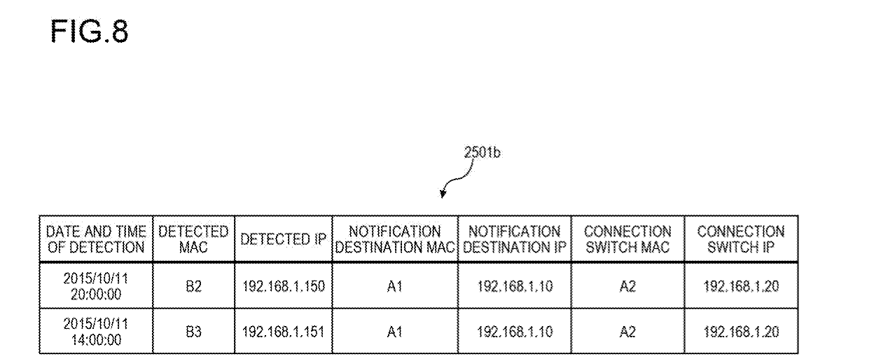

FIG. 8 illustrates another example of the detected-equipment table within the representative L2 switch according to the first case. A detected-equipment table 2501b in FIG. 8 is an example of information after being updated from the detected-equipment table 2501a in FIG. 6, based on a processing result (there is no problem in the connection to the server 1305) in FIG. 7. The update unit 2200 of the representative L2 switch 1201 reflects the network connection state information of the server 1305 into the detected-equipment table 2501a. Specifically, the update unit 2200 updates the item of the date and time of detection. Thus, the date and time of the detection of the first row in the detected-equipment table 2501b becomes 20 o'clock at which the connection check instruction is transmitted. The management server notification unit 2300 of the representative L2 switch 1201 notifies the management server 1301 of the network connection state information of the server 1305.

Second Case

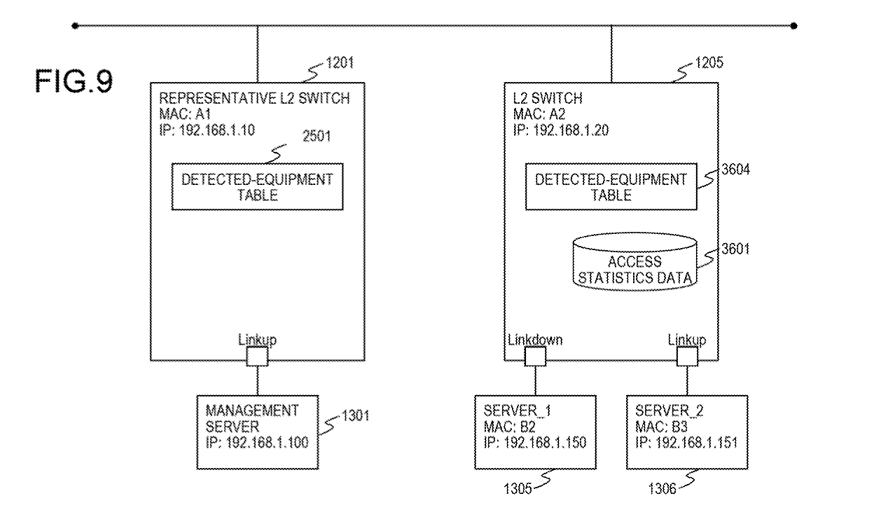

FIG. 9 illustrates an example of a configuration of an apparatus according to a second case. In the apparatus according to the second case in FIG. 9, constitutional elements similar to the constitutional elements in FIG. 5 are assigned with the same reference numerals. In FIG. 5, the server 1305 is in the Linkup state (coupled state). On the other hand, the server 1305 is in the Linkdown state in FIG. 9.

It is assumed that a connection check instruction is issued from the representative L2 switch 1201 at 20 o'clock. The response determination unit 3200 of the L2 switch 1205 references the access statistics data 3601a in FIG. 7 and identifies that the proportion of the connection state is 100% at 20 o'clock, which is the connection check instruction time. Thus, the response determination unit 3200 determines that the connection state of the server is to be determined.

Here, the connection state determination unit 3300 of the L2 switch 1205 checks the port coupled to the server 1305 and determines that the server is in the Linkdown state (uncoupled state). The statistics update unit 3500 of the L2 switch 1205 reflects the connection state information (Linkdown) into the access statistics data 3601. The connection state determination unit 3300 reflects the connection state information into the detected-equipment table 3604. Thereafter, the representative switch notification unit 3400 notifies the representative L2 switch 1201 of the network connection state information of the target equipment.

The update unit 2200 of the representative L2 switch 1201 updates the detected-equipment table 2501 stored in the storage unit 2500, based on the received network connection state information of the target equipment. The update unit 2200 updates the date and time of the detection even when the connection state is the Linkdown state. The management server notification unit 2300 of the representative L2 switch 1201 notifies the management server 1301 of the network connection state information of the server 1305.

Third Case

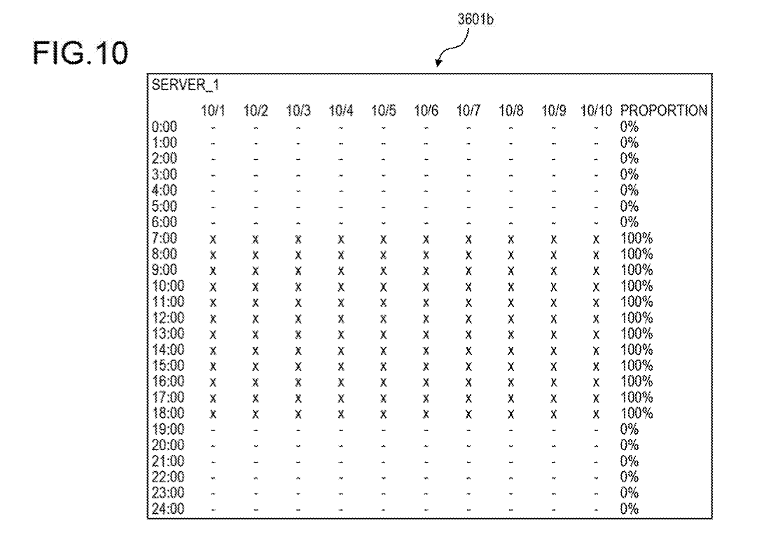

FIG. 10 is a diagram illustrating an example of access statistics data according to a third case. In the third case, the configuration of, for example, the switches and the servers is similar to the configuration in FIG. 5. The access statistics data 3601b in FIG. 10 is statistical data related to the server 1305, in the access statistics data 3601 within the L2 switch 1205 in FIG. 5. In the access statistics data 3601b, the network connection states at 0 minute of each hour in the past 10 days (October 1 to October 10) are stored.

Here, the server 1305 is assumed as a server that is stopped during night. Thus, the network connection states at 0 o'clock to 6 o'clock and 19 o'clock to 24 o'clock from October 1 to October 10 are represented as “-” in the access statistics data 3601b. The network connection state of the “-” represents a state where the server is uncoupled. The server 1305 operates in daytime (except for nighttime). Thus, the network connection states at 7 o'clock to 18 o'clock from October 1 to October 10 are represented as “x” indicating a state of being coupled, in the access statistics data 3601b.

Here, it is assumed that a connection check instruction is issued from the representative L2 switch 1201 at 20 o'clock. The response determination unit 3200 of the L2 switch 1205 references the access statistics data 3601b in FIG. 10 and identifies that the proportion of the connection state is 0% at 20 o'clock, which is the connection check instruction time. Thus, the response determination unit 3200 determines that the connection state of the server is not to be determined. The representative switch notification unit 3400 of the L2 switch 1205 notifies the representative L2 switch 1201 of a recheck instruction. The reception unit 2400 of the representative L2 switch 1201 receives the recheck instruction. When the recheck instruction is received, the representative L2 switch 1201 transmits the connection check instruction again after a predetermined time is elapsed.

Fourth Case

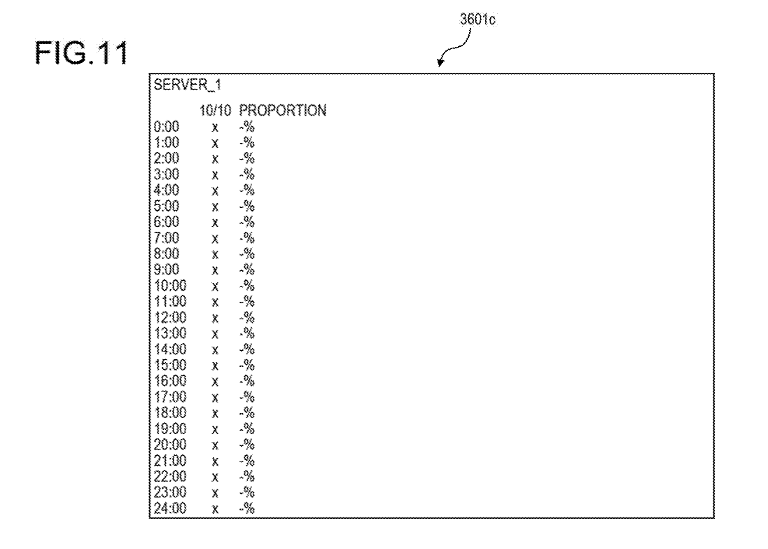

FIG. 11 is a diagram illustrating an example of access statistics data according to a fourth case. In the fourth case, the configuration of, for example, the switches and the servers is similar to the configuration in FIG. 5. The access statistics data 3601c in FIG. 11 is statistical data related to the server 1305, in the access statistics data 3601 within the L2 switch 1205 in FIG. 5. In the access statistics data 3601c, the network connection states at 0 minute of each hour in the past 1 day (October 10) are stored. In the access statistics data 3601c, information on the network connection state for only 1 day is stored and thus the proportion is not yet calculated.

Since the information on the proportion of the connection states is absent, the response determination unit 3200 of the L2 switch 1205 determines that a connection state of the server is not to be determined. The representative switch notification unit 3400 of the L2 switch 1205 notifies the representative L2 switch 1201 of a recheck instruction. The reception unit 2400 of the representative L2 switch 1201 receives the recheck instruction. When the recheck instruction is received, the representative L2 switch 1201 transmits the connection check instruction again after a predetermined time is elapsed.

Fifth Case

FIG. 12 is a diagram illustrating an example of access statistics data according to a fifth case. In the fifth case, the configuration of, for example, the switches and the servers is similar to the configuration in FIG. 5. The access statistics data 3601d in FIG. 12 is statistical data related to the server 1305, in the access statistics data 3601 within the L2 switch 1205 in FIG. 5. In the access statistics data 3601d, the network connection states at 0 minute of each hour in the past 10 days (October 1 to October 10) are stored.

The network connection states from 0 o'clock, October 1 to 18 o'clock, October 4 are represented as “x” indicating a state of being coupled to the network, in the access statistics data 3601d. The network connection states from 19 o'clock, October 4 to 8 o'clock, October 7 are represented as “-” indicating that the server is uncoupled to the network, in the access statistics data 3601d. The network connection states from 9 o'clock, October 7 to 24 o'clock, October 10 are represented as “x” indicating a state of being coupled to the network, in the access statistics data 3601d. Thus, in the access statistics data 3601d, the connection proportion for 0 o'clock to 8 o'clock is 70%, for 9 o'clock to 18 o'clock is 80%, and for 19 o'clock to 24 o'clock is 70%.

In the response determination unit 3200, a threshold value (e.g. 80%) is set when a connection state is determined. It is assumed that a connection check instruction is issued from the representative L2 switch 1201 at 20 o'clock. The 20 o'clock, which is the connection check instruction time, corresponds to a connection state of 70% and thus, the response determination unit 3200 determines that the connection state of the server is not to be determined. The representative switch notification unit 3400 of the L2 switch 1205 notifies the representative L2 switch 1201 of a recheck instruction. The reception unit 2400 of the representative L2 switch 1201 receives the recheck instruction. When the recheck instruction is received, the representative L2 switch 1201 transmits the connection check instruction again after a predetermined time is elapsed.

As such, the L2 switch 1205 checks whether the present time falls within a time zone during which equipment is temporarily detached from the network in a planned way due to, for example, powering-OFF during night by a scheduled operation or a periodically performed maintenance work, based on the access statistics data 3601. As a result, the L2 switch 1205 may determine whether the connection state of equipment is to be notified in the present time zone. The L2 switch 1205 notifies the management server 1301 side of the connection state of equipment at a time zone during which the connection state of equipment is to be determined. On the other hand, the L2 switch 1205 does not notify the management server 1301 side of the connection state of the equipment at a time zone during which the connection state of equipment is not to be determined.

As a result, the management server 1301 may prevent erroneous information from being transmitted to the management server 1301. The erroneous information indicates that equipment is in a state of being uncoupled to the network while the equipment is only temporarily detached from the network due to, for example, maintenance or a scheduled operation.

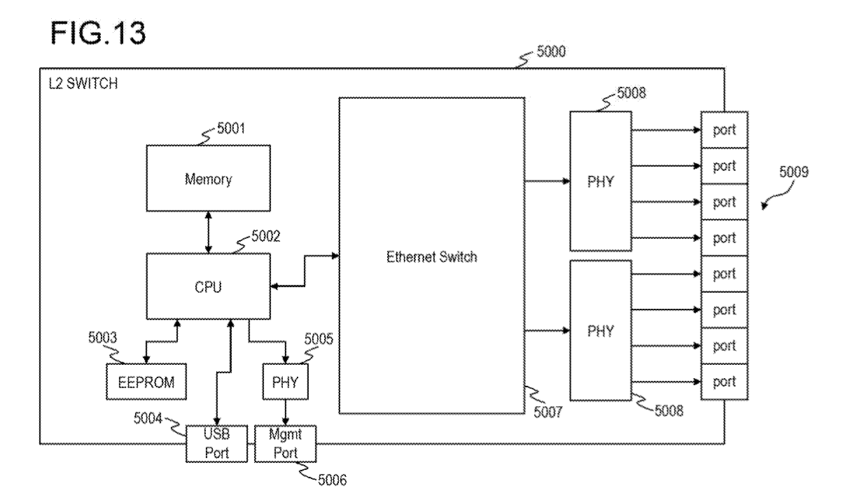

FIG. 13 is a diagram illustrating an example of a hardware configuration of the representative L2 switch and the L2 switch. The representative L2 switch 1201 and the L2 switches 1202, 1203, and 1205 have a similar hardware configuration. In the following, the representative L2 switch 1201 and the L2 switches 1202, 1203, and 1205 are collectively denoted as an L2 switch 5000. The L2 switch 5000 includes a memory 5001, a central processing unit (CPU) 5002, an electrically erasable programmable read-only memory (EEPROM) 5003, a universal serial bus (USB) port 5004, a physical layer chip (PHY) 5005, PHYs 5008, an Mgmt port 5006, an Ethernet Switch 5007, and ports 5009.

The CPU 5002 executes a program to operate as the frame detection unit 2710, the target frame determination unit 2720, the detected-data check unit 2730, and the communication data generation unit 2740 in the representative L2 switch 1201. The CPU 5002 executes a program to operate as the frame detection unit 3710, the target frame determination unit 3720, the detected-data check unit 3730, and the communication data generation unit 3740 in the L2 switches 1202, 1203, and 1205. The CPU 5002 may also operate as the update unit 2200 and the monitor unit 2100 in the representative L2 switch 1201. The CPU 5002 may also operate as the response determination unit 3200, the connection state determination unit 3300, and the statistics update unit 3500 in the L2 switches 1202, 1203, and 1205.

The memory 5001 operates as the storage unit 2500 and the storage unit 3600. The memory 5001 stores therein a program executed by the CPU 5002, data obtained through operations of the CPU 5002, or data used in the processing of the CPU 5002. Specifically, the memory 5001 stores therein the detected-equipment table 2501, the access statistics table 2502, the MAC address table 2503, and the port linkup information 2504 in the representative L2 switch 1201. The memory 5001 includes the setting data 3610, the access statistics data 3601, the MAC address table 3602, the port linkup information 3603, and the detected-equipment table 3604 in the L2 switches 1202, 1203, and 1205. The EEPROM 5003 is a non-volatile memory and stores therein a program or data to be stored even when the L2 switch 5000 is powered OFF.

The USB port 5004 is a connection port into which a USB cable is inserted. The Mgmt port 5006 is a port used in managing a switch, and is a serially-coupled console port or a port of a local area network. The PHYs 5005 and 5008 convert a logical signal into an electrical signal in an interface such as the Ethernet. The PHY 5005 converts a signal between the CPU 5002 and the Mgmt port 5006.

The Ethernet Switch 5007 is, for example, a switching hub and is equipped with a switching function. The Ethernet Switch 5007 reads an address of a transmission destination within a packet transmitted from a network card by the switching function and transfers data to a corresponding port. The PHYs 5008 are communicably coupled to the Ethernet Switch 5007 and the ports 5009. The ports 5009 are connection ports for equipment coupled to the L2 switch 5000.

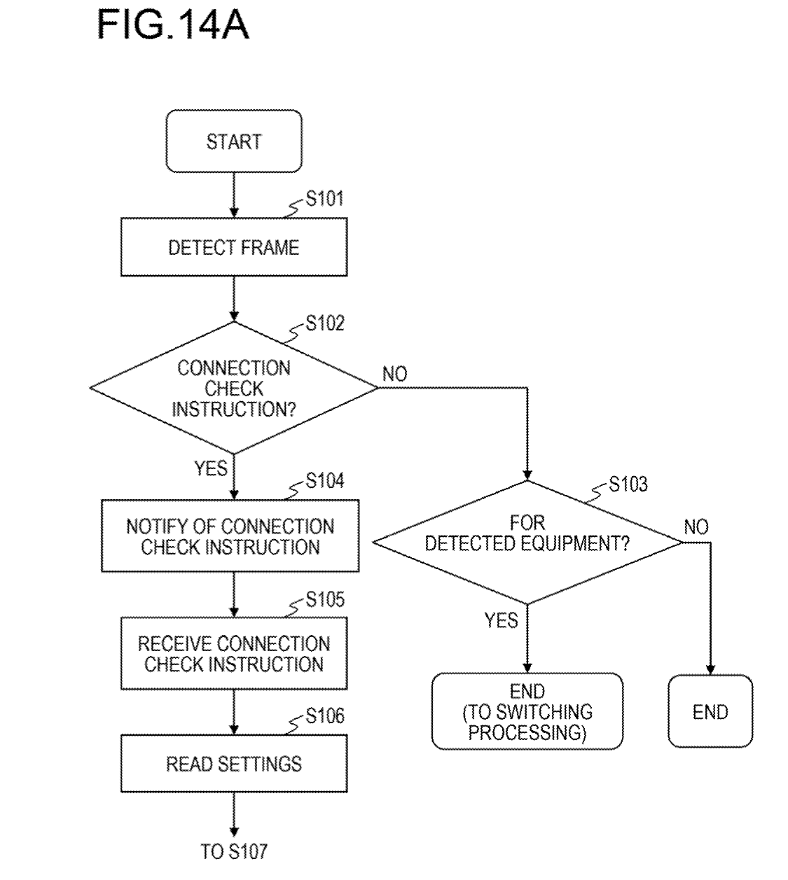

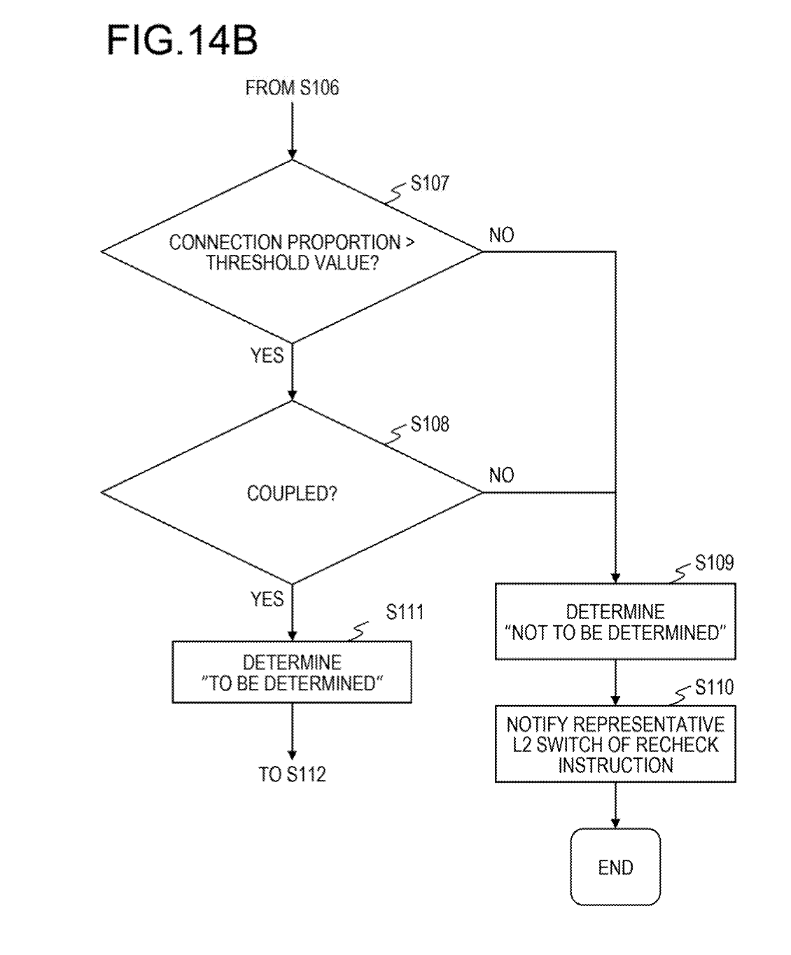

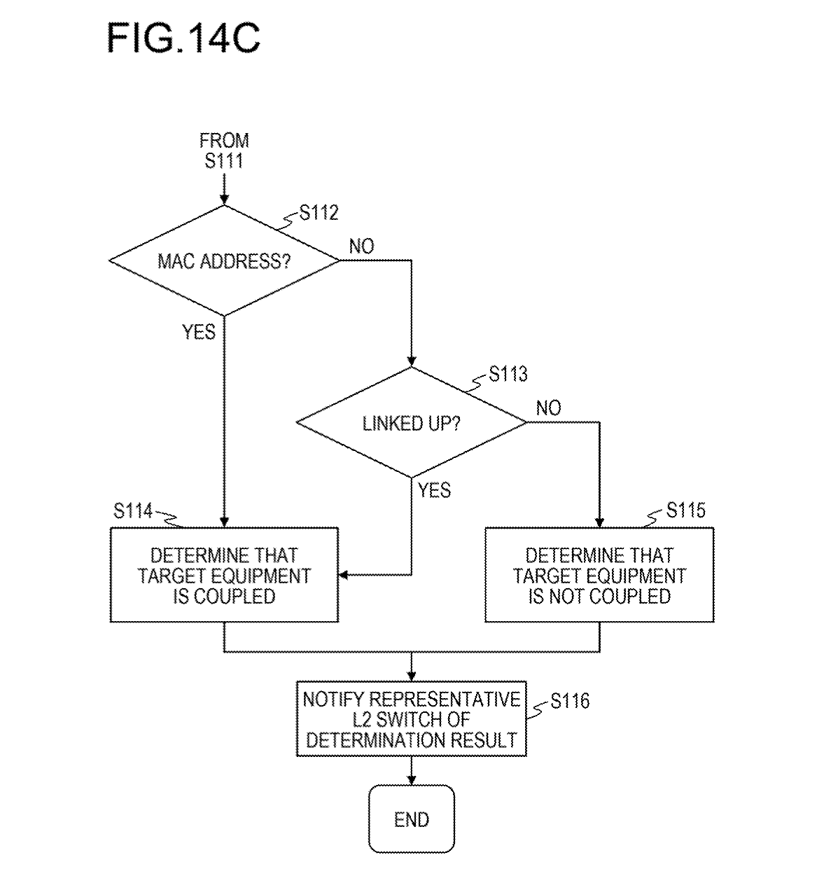

FIG. 14A to FIG. 14C are flowcharts illustrating an example of processing performed by the L2 switch. The frame detection unit 3710 detects a frame sent from another L2 switch or the representative L2 switch (S101). The target frame determination unit 3720 determines whether a connection check instruction transmitted from the representative L2 switch is included in the received frame (S102). When it is determined that a connection check instruction is not included in the received frame (NO at S102), the target frame determination unit 3720 determines whether the received frame is addressed to equipment registered in the detected-equipment table 3604 (S103). When it is determined that the received frame is addressed to equipment registered in the detected-equipment table 3604 (YES at S103), the L2 switch ends the processing according to the present embodiment and performs switching processing. When it is determined that the received frame is not addressed to equipment registered in the detected-equipment table 3604 (NO at S103), the L2 switch ends the processing without performing any processing relating to the received frame.

When it is determined that a connection check instruction is included in the received frame (YES at S102), the target frame determination unit 3720 notifies the reception unit 3100 of the connection check instruction (S104). The reception unit 3100 receives the connection check instruction (S105). The response determination unit 3200 sets the threshold value stored in the setting data 3610 to the response determination unit 3200 (S106). The response determination unit 3200 determines based on the access statistics data 3601 stored in the storage unit 3600 whether the connection proportion corresponding to the present time for the equipment (target equipment), which is the target of the connection check, is greater than a predetermined threshold value (S107). When it is determined that the connection proportion corresponding to the present time for the target equipment is greater than the predetermined threshold value (YES at S107), the response determination unit 3200 determines based on the access statistics data 3601 whether the target equipment is coupled within a predetermined past time period (S108).

When it is determined that the connection proportion corresponding to the present time for the target equipment is less than the predetermined threshold value (No at S107) or when it is determined that the target equipment is not coupled within the predetermined past time period (No at S108), the response determination unit 3200 determines that the connection state of the target equipment is not to be determined (S109). The representative switch notification unit 3400 notifies the representative L2 switch 1201 of a recheck instruction (S110). When S110 is ended, the processing of the L2 switch side is ended.

When it is determined that the target equipment is coupled within the predetermined past time period (YES at S108), the response determination unit 3200 determines that the connection state of the target equipment is to be determined (S111).

The connection state determination unit 3300 determines whether the MAC address of the target equipment is registered in the MAC address table 3602 (S112). When it is determined that the MAC address is not registered (NO at S112), the connection state determination unit 3300 determines based on the port linkup information 3603 whether the port of the target equipment is linked up (S113). When it is determined that the MAC address is registered (YES at S112) or the port of the target equipment is linked up (YES at S113), the connection state determination unit 3300 determines that the target equipment is coupled (S114). On the other hand, when it is determined that the port of the target equipment is not linked up (NO at S113), the connection state determination unit 3300 determines that the target equipment is not coupled (S115).

The representative switch notification unit 3400 notifies the representative L2 switch 1201 of the determination result for the target equipment (S116).

As such, the L2 switch 1203 checks whether the present time falls within a time zone during which equipment is temporarily detached from the network in a planned way due to, for example, powering-OFF during night by a scheduled operation or a periodically performed maintenance work, based on the access statistics data 3601. As a result, the L2 switch 1203 may determine whether the connection state of the equipment is to be determined in the present time zone. The L2 switch 1203 notifies the management server 1301 side of the connection state of the equipment at a time zone during which the connection state of the equipment is to be notified. On the other hand, the L2 switch 1203 does not notify the management server 1301 side of the connection state of the equipment at a time zone during which the connection state of the equipment is not to be determined.

As a result, the management server 1301 may prevent erroneous information from being transmitted to the management server 1301. The erroneous information indicates that equipment is in a state of being uncoupled to the network while the equipment is only temporarily detached from the network due to, for example, maintenance or a scheduled operation.

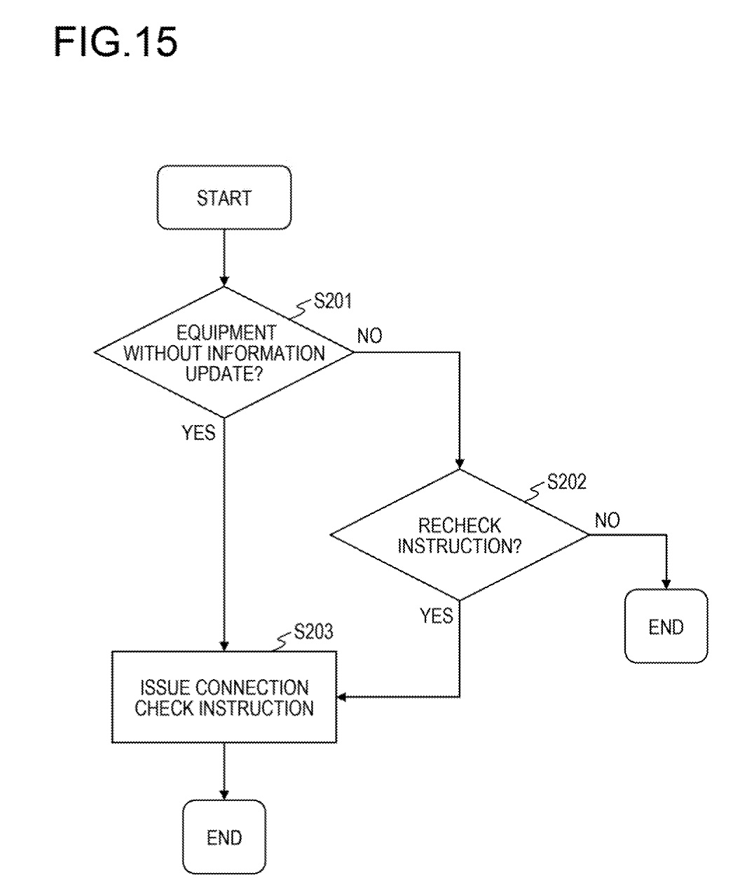

FIG. 15 is a flowchart illustrating an example of processing performed by the monitor unit of the representative L2 switch. The monitor unit 2100 of the representative L2 switch 1201 periodically performs the processing. The monitor unit 2100 determines based on the detected-equipment table 2501 whether there is equipment for which information registered in the detected-equipment table 2501 is not updated for a predetermined period of time (S201). When it is determined that there is no equipment for which information registered in the detected-equipment table 2501 is not updated for the predetermined period of time (NO at S201), the monitor unit 2100 determines whether a recheck instruction is received from an L2 switch side (S202). When it is determined that no recheck instruction is received from an L2 switch side (NO at S202), the monitor unit 2100 ends the processing.

When it is determined that there is equipment for which information registered in the detected-equipment table 2501 is not updated for the predetermined period of time (YES at S201) or when it is determined that a recheck instruction is received from an L2 switch side (YES at S202), the monitor unit 2100 transmits a connection check instruction to an L2 switch to which the target equipment is coupled (S203). Thereafter, the processing (periodically performed processing) performed by the monitor unit 2100 is ended.

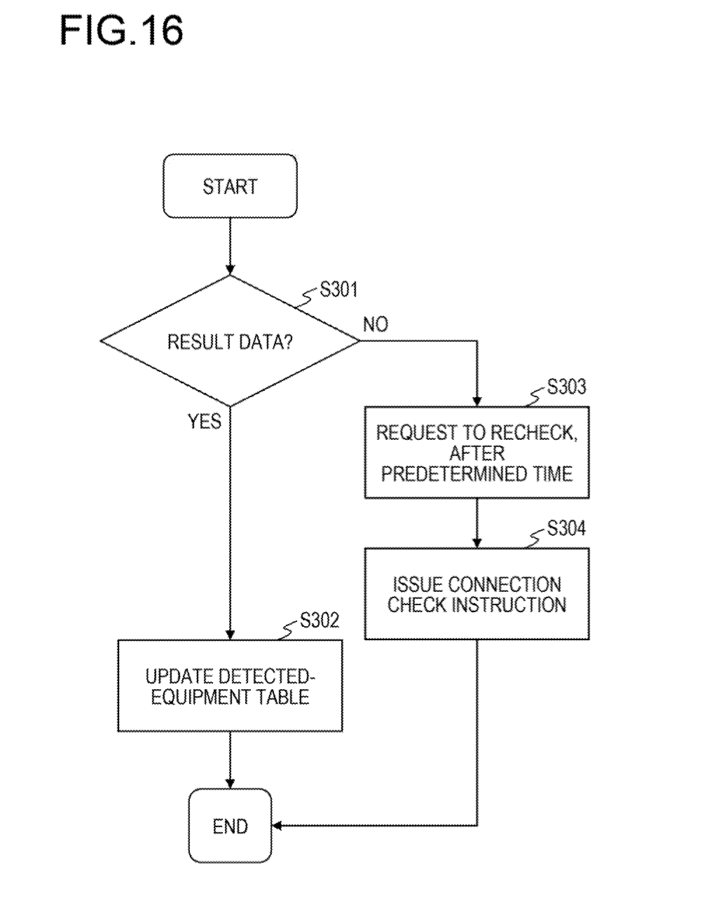

FIG. 16 is a flowchart illustrating an example of processing performed by the update unit of the representative L2 switch. The update unit 2200 determines whether the received frame is result data corresponding to a connection check instruction (S301). When it is determined that the received frame is result data (YES at S301), the update unit 2200 updates the detected-equipment table 2501 (S302). When S302 is ended, the update unit of the representative L2 switch ends the processing.

When it is determined that the received frame is not result data (NO at S301), the update unit 2200 notifies, after a predetermined time is elapsed, the monitor unit 2100 of an instruction to issue a connection check instruction again (S303). The monitor unit 2100 issues a connection check instruction to the L2 switch again (S304). Thereafter, the processing of the representative L2 switch side is ended.

As such, the L2 switch 1203 checks based on the access statistics data 3601 whether the present time falls within a time zone during which equipment is temporarily detached from the network in a planned way due to, for example, powering-OFF during night by a scheduled operation or a periodically performed maintenance work. Thus, the L2 switch 1203 may determine whether the connection state of equipment is to be notified in the present time zone. The L2 switch 1203 notifies the management server 1301 side of the connection state of the equipment at a time zone during which the connection state of equipment is to be determined. On the other hand, the L2 switch 1203 does not notify the management server 1301 side of the connection state of the equipment at a time zone during which the connection state of equipment is not to be determined.

Thus, the management server 1301 may prevent erroneous information from being transmitted to the management server 1301. The erroneous information indicates that equipment is in a state of being uncoupled to the network while the equipment is only temporarily detached from the network due to, for example, maintenance or a scheduled operation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiment has been described in detail, it should be understood that the various changes, substitutions, and alterations could be made hereto without departing from the spirit and scope of the invention.

What is claimed is:

1. A management system, comprising:
a first switch including:
a first memory, and
a first processor coupled to the first memory and the first processor configured to
transmit a first instruction when information on a first connection state of first equipment is not updated; and
a second switch including:
a second memory, and
a second processor coupled to the second memory and the second processor configured to
receive the first instruction,
determine, on basis of second information, whether the first connection state is to be notified to the first switch at a present time, the second information being related to past connection states of the first equipment, and
notify, in a case where it is determined that the first connection state is not to be notified, the first switch of an instruction to transmit the first instruction again after a predetermined time is elapsed.

2. The management system according to claim 1, wherein
the second processor is configured to
perform the determination on basis of a connection proportion calculated on basis of the past connection states of the first equipment at times corresponding to the present time.

3. A switch, comprising:
a memory; and
a processor coupled to the memory and the processor configured to receive a first instruction from a switch device,
determine, on basis of second information, whether a first connection state of first equipment is to be notified to the switch device at a present time, the second information being related to past connection states of the first equipment, and
notify, in a case where it is determined that the first connection state is not to be notified, the switch device of an instruction to transmit the first instruction again after a predetermined time is elapsed.

4. The switch according to claim 3, wherein
the processor is configured to
perform the determination on basis of a connection proportion calculated on basis of the past connection states of the first equipment at times corresponding to the present time.

5. A non-transitory computer-readable recording medium having stored therein a program that causes a computer to execute a process, the process comprising:
receiving a first instruction from a switch device;
determining, on basis of second information, whether a first connection state of first equipment is to be notified to the switch device at a present time, the second information being related to past connection states of the first equipment; and
notifying, in a case where it is determined that the first connection state is not to be notified, the switch device of an instruction to transmit the first instruction again after a predetermined time is elapsed.

6. The non-transitory computer-readable recording medium according to claim 5, the process comprising:
performing the determination on basis of a connection proportion calculated on basis of the past connection states of the first equipment at times corresponding to the present time.
